(19) United States
(12) Patent Application Publication
(10) Pub. No.: US 2025/0103259 A1
(43) Pub. Date: Mar. 27, 2025

(54) INFORMATION PROCESSING APPARATUS, CONTROL METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: YOSHIRO MIHIRA, Tokyo (JP)

(21) Appl. No.: 18/884,236

(22) Filed: Sep. 13, 2024

(30) Foreign Application Priority Data
Sep. 25, 2023 (JP) 2023-161708

(51) Int. Cl. G06F 3/12

(52) U.S. Cl. CPC G06F 3/126; G06F 3/1204; G06F 3/1292

(57) ABSTRACT

Based on a fact that a communication apparatus discovered firstly by a search is an apparatus of a first type, a predetermined communication with the communication apparatus discovered firstly by the search is executed without displaying, after the search processing is executed, a selection screen for accepting selection of one of a plurality of communication apparatuses from a user. Based on a fact that the communication apparatus discovered firstly by the search is an apparatus of a second type different from the first type, the selection screen is displayed, the plurality of communication apparatuses discovered by the search are displayed on the selection screen, and the predetermined communication with the communication apparatus selected by the user from the plurality of communication apparatuses displayed on the selection screen is executed.

### BACKGROUND OF THE INVENTION

### Field of the Invention

The present invention relates to an information processing apparatus capable of communicating with a communication apparatus, a control method executed in the information processing apparatus, and a non-transitory computer-readable storage medium storing a program.

### Description of the Related Art

To connect an information processing apparatus such as a personal computer or a smartphone to a communication apparatus such as a network printer and use it, it may be necessary to perform registration processing of the communication apparatus in the information processing apparatus to decide an apparatus that operates in cooperation with the communication apparatus. As the registration processing, search processing is performed first, and a communication apparatus selected from communication apparatuses discovered by the search processing is registered.

Japanese Patent Laid-Open No. 2013-131945 describes that when only one communication apparatus is discovered by performing a search, it is automatically registered without displaying a list. It is also described that when a plurality of communication apparatuses are discovered, a list is displayed.

### SUMMARY OF THE INVENTION

When an apparatus search is performed and processing is executed for discovered apparatuses, it is necessary to improve convenience.

The present invention provides an information processing apparatus that improves convenience when an apparatus search is performed and processing is executed for discovered apparatuses, a control method, and a program.

The present invention in one aspect provides a control method for an information processing apparatus including a predetermined application program, comprising: executing search processing for searching for a communication apparatus by the information processing apparatus; and executing predetermined communication with a communication apparatus discovered by a search started by the search processing, wherein based on a fact that a communication apparatus discovered firstly by the search is an apparatus of a first type, the predetermined communication with the communication apparatus discovered firstly by the search is executed without displaying, after the search processing is executed, a selection screen for accepting selection of one of a plurality of communication apparatuses from a user, based on a fact that the communication apparatus discovered firstly by the search is an apparatus of a second type different from the first type, the selection screen is displayed, the plurality of communication apparatuses discovered by the search are displayed on the selection screen, and the predetermined communication with the communication apparatus selected by the user from the plurality of communication apparatuses displayed on the selection screen is executed.

According to the present invention, it is possible to improve convenience when an apparatus search is performed and processing is executed for discovered apparatuses.

Further features of the present invention will become apparent from the following description of exemplary embodiments with reference to the attached drawings.

### BRIEF DESCRIPTION OF THE DRAWINGS

FIG. 1 is a view showing the arrangement of a system including an information processing apparatus and a communication apparatus;

FIG. 2 is a block diagram showing components of the information processing apparatus and the communication apparatus;

FIGS. 3A and 3B are flowcharts illustrating processing in the information processing apparatus;

FIGS. 4A to 4D are views each showing a user interface screen;

FIGS. 5A and 5B are views each showing a user interface;

FIGS. 6A and 6B are flowcharts illustrating processing in an information processing apparatus;

FIGS. 7A to 7D are views each showing a user interface screen; and

FIGS. 8A and 8B are views each showing a user interface screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

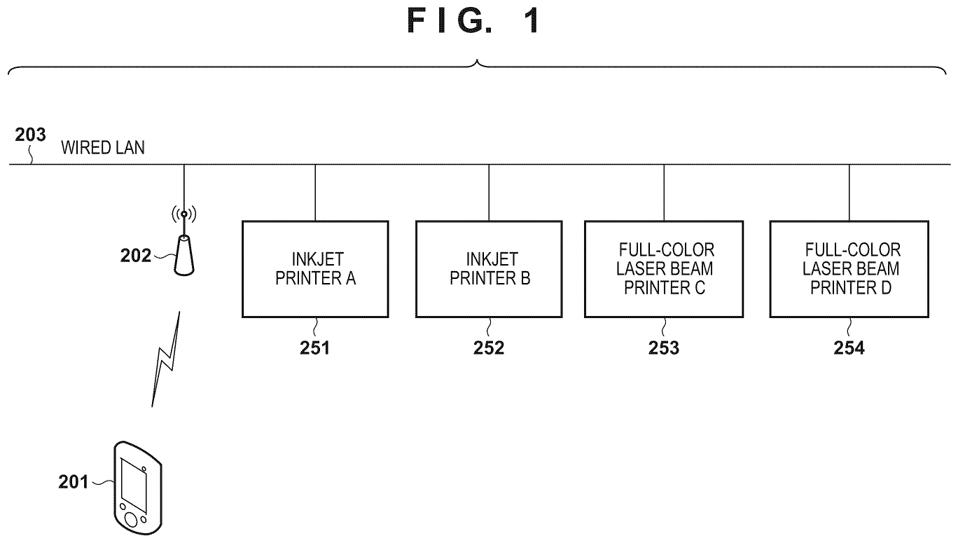

FIG. 1 is a view showing an example of the arrangement of a system including an information processing apparatus and a communication apparatus according to this embodiment. As shown in FIG. 1, an information processing apparatus 201 can wirelessly be connected to an access point 202, and communication apparatuses 251, 252, 253, and 254 and the access point 202 are connected via a wired LAN 203. That is, this embodiment assumes that the information processing apparatus 201 can communicate with the access point 202, and the communication apparatuses 251 to 254 can communicate with the access point 202.

In this embodiment, a smartphone is exemplified as the information processing apparatus 201 but the present invention is not limited to this, and various kinds of apparatuses such as a portable terminal, a notebook PC, a tablet terminal, a Personal Digital Assistant (PDA), and a digital camera are applicable. Furthermore, in this embodiment, printers are exemplified as the communication apparatuses 251 to 254 but the present invention is not limited to this, and various kinds of apparatuses are applicable as long as they can communicate with the information processing apparatus 201. For example, concerning a printer, an inkjet printer adopting an inkjet printing method, a full-color laser beam printer adopting an electrophotographic method, a monochrome printer, and the like are applicable. Furthermore, not only a printer but also a copying machine, a facsimile apparatus, a portable terminal, a smartphone, a notebook PC, a tablet terminal, a Personal Digital Assistant (PDA), a digital camera, and the like are applicable. In addition, a multi-function peripheral having a copying function, a FAX function, and a print function is applicable. In this embodiment, as an example, assume that the communication apparatuses 251 and 252 are inkjet printers and the communication apparatuses 253 and 254 are laser beam printers. The access point 202 is a network apparatus having an access point function, and is, for example, a router.

This embodiment will describe a communication apparatus search executed by the information processing apparatus 201. The communication apparatus search is, for example, processing executed in step S303 or S502 to be described later. More specifically, for example, the information processing apparatus 201 transmits a search packet to the wired LAN 203 via the access point 202. For example, the packet is transmitted by broadcast or multicast, thereby transmitting a search request to a network. Each of the communication apparatuses 251 to 254 receives the packet, and transmits a response packet to the information processing apparatus 201. Then, the information processing apparatus 201 displays a search result on a display unit based on the received response packets. At this time, for example, as shown in FIG. 5B, the search result is displayed as a list. If the user selects a desired communication apparatus on the list, the selected communication apparatus is registered in an application program (to be referred to as an application hereinafter). Note that more specifically, the registration of the communication apparatus in the application includes processing in which the application acquires various kinds of information concerning the communication apparatus from the communication apparatus and processing in which the application stores/manages the acquired information. Upon completion of the registration of the communication apparatus in the application, the user can instruct the registered communication apparatus to perform processing on the application. In a case where the application is a print application, the processing is print processing for desired data. Note that if a plurality of communication apparatuses are registered in the application, the communication apparatus selected by the user from the plurality of communication apparatuses is instructed to perform the processing.

Referring to FIG. 1, the communication apparatuses 251 to 254 are connected to the wired LAN 203. However, as long as the communication apparatuses have a wireless communication function, they may wirelessly be connected to the access point 202. Then, the information processing apparatus 201 may search for the communication apparatuses via the access point 202.

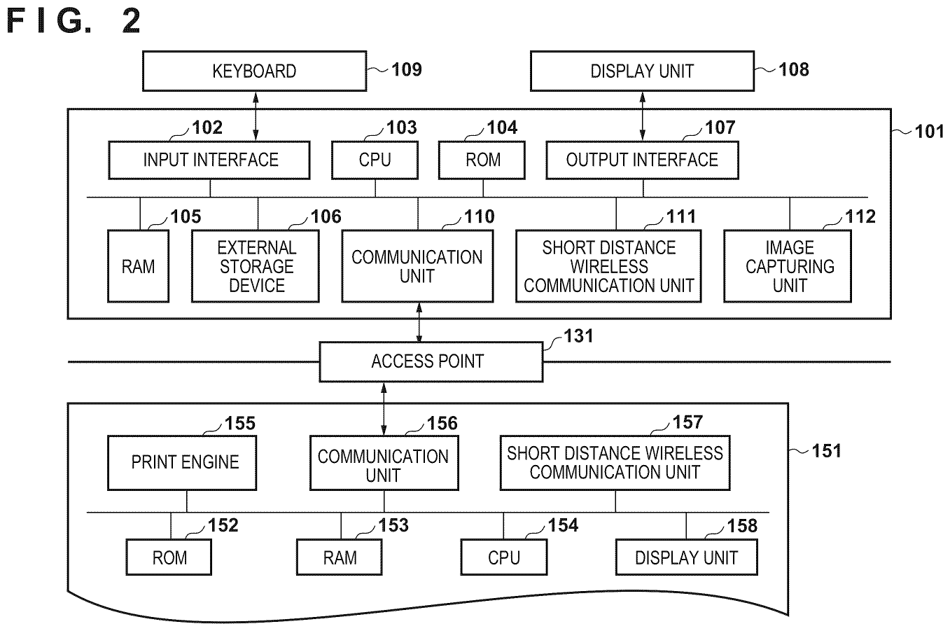

Components of an information processing apparatus and a communication apparatus capable of communicating with the information processing apparatus will be described with reference to a block diagram shown in FIG. 2. An information processing apparatus 101 shown in FIG. 2 corresponds to the information processing apparatus 201 shown in FIG. 1, a communication apparatus 151 shown in FIG. 2 corresponds to each of the communication apparatuses 251 to 254 shown in FIG. 1, and an access point 131 shown in FIG. 2 corresponds to the access point 202 shown in FIG. 1. Although this embodiment will exemplify the following components, the present invention is not limited to functions shown in FIG. 2. Apparatuses that are applicable to the information processing apparatus 101 and the communication apparatus 151 can appropriately include components corresponding to executable functions.

The information processing apparatus 101 includes an input interface 102, a CPU 103, a ROM 104, a RAM 105, an external storage device 106, an output interface 107, a display unit 108, a communication unit 110, a short distance wireless communication unit 111, and an image capturing unit 112. The CPU 103, the ROM 104, the RAM 105, and the like form a computer of the information processing apparatus 101 for executing a program.

The input interface 102 is an interface for accepting data input and instruction operations from the user when an operation unit such as a keyboard 109 is operated. Note that the operation unit may include a physical keyboard and physical buttons, or may include a software keyboard and software buttons displayed on the display unit 108. That is, the input interface 102 may accept input from the user via the display unit 108.

The CPU 103 is a system control unit and controls the whole information processing apparatus 101 such as execution of an application program. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and the work memory of the CPU 103.

The external storage device 106 stores an application program configured to execute a network setup of the communication apparatus 151, a printer management application, a print information generation program that generates print information interpretable by the communication apparatus 151, and the like. Each program is stored in the external storage device 106 by being installed from an external server (not shown) by, for example, Internet communication via the communication unit 110. A service registration application is an application program configured to transmit information acquired from the communication apparatus 151, personal information of the user acquired by the information processing apparatus 101, and the like to a service management server (not shown). The application program (setup application) configured to execute a network setup of the communication apparatus 151 is an application program configured to set an access point as the connection destination of the communication apparatus 151. The printer management application is an application configured to manage information of the printer. Note that the service registration application, the setup application, the printer management application, and the print information generation program (print application) may be formed as different applications or one application. This embodiment assumes that the service registration application, the setup application, the printer management application, and the print information generation program are formed as one application, and the one application will be referred to as a predetermined application hereinafter.

The output interface 107 is an interface configured to perform control for causing the display unit 108 to display data or make a notification concerning the state of the information processing apparatus 101. The display unit 108 is formed by a Light-Emitting Diode (LED), a Liquid Crystal Display (LCD), or the like and displays data or makes a notification concerning the state of the information processing apparatus 101. The image capturing unit 112 is, for example, a camera that captures the outside.

The communication unit 110 is a component connected to the apparatus such as the communication apparatus 151 or the access point 131 to execute data communication. For example, the communication unit 110 can be connected to an access point (not shown) in the communication apparatus 151. The communication unit 110 includes, as an access point in the information processing apparatus 101, an access point for connection to the apparatus such as the communication apparatus 151. This access point is generally called tethering. Note that a communication unit 156 of the communication apparatus 151 can be connected to the access point. When the communication unit 110 enables the access point, the information processing apparatus 101 operates as the access point. When the communication unit 156 and the access point in the communication unit 110 are connected, the information processing apparatus 101 and the communication apparatus 151 can communicate with each other. If the communication unit 110 of the information processing apparatus 101 is connected to the Internet, the communication apparatus 151 can also be connected to the Internet via the information processing apparatus 101. Note that in this embodiment, the information processing apparatus 101 can communicate with the communication apparatus 151 via an external apparatus existing outside the information processing apparatus 101 and the communication apparatus 151. Note that examples of the external apparatus include an external access point (the access point 131 or the like) existing outside the information processing apparatus 101 and the communication apparatus 151, and an apparatus, other than the access point, that can relay communication. For example, a device such as a wireless LAN router is used as the access point 131. The method of connecting the information processing apparatus 101 and the communication apparatus 151 via the external access point is called an infrastructure connection method.

The short distance wireless communication unit 111 is a component wirelessly connected to the apparatus such as the communication apparatus 151 in a short distance to execute data communication, and performs communication by a communication method different from that of the communication unit 110. The short distance wireless communication unit 111 can be connected to, for example, a short distance wireless communication unit 157 in the communication apparatus 151. As the communication method, for example, Near Field Communication (NFC), Bluetooth® Classic, Bluetooth Low Energy (BLE), a Wi-Fi Aware, or the like is used.

The communication apparatus 151 includes a ROM 152, a RAM 153, a CPU 154, a print engine 155, the communication unit 156, the short distance wireless communication unit 157, and a display unit 158. The ROM 152, the RAM 153, the CPU 154, and the like form a computer of the communication apparatus 151 for executing a program.

The communication unit 156 includes, as the access point in the communication apparatus 151, an access point for connection to the external apparatus such as the information processing apparatus 101. Note that the access point can be connected to the communication unit 110 of the information processing apparatus 101. If the communication unit 156 enables the access point, the communication apparatus 151 operates as the access point. Note that the communication unit 156 may directly, wirelessly be connected to the information processing apparatus 101 or may wirelessly be connected to the information processing apparatus 101 via the access point 131. The wireless communication method used by the communication unit 156 is, for example, a communication standard based on the IEEE802.11 series. The communication unit 156 may include a hardware component functioning as an access point or may operate as an access point by software for functioning as an access point.

A mode and a connection method of executing wireless communication using the communication unit 156 will now be described.

### Direct Connection Method

Direct connection indicates a form in which apparatuses are wirelessly connected directly (that is, by Peer to Peer) without intervention of an external apparatus such as the AP 131. Direct connection is also called Peer to Peer connection (P2P connection). As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the communication apparatus 151 is neither the master station nor the slave station. More specifically, first, one of devices to communicate with each other issues a device search command and searches for a device to be connected in the WFD mode. After the other device serving as a communication partner is discovered, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by a device search command. After the software AP is discovered, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station and can thus decide a specific frequency band and channel to be used for communication in the direct connection method. In this embodiment, the communication apparatus 151 can use a channel corresponding to the 2.4-GHz frequency band and a channel corresponding to the 5-GHz frequency band for communication in the direct connection method.

### Infrastructure Connection Method

Infrastructure connection is a connection form in which devices (for example, the information processing apparatus 101 and the communication apparatus 151) to communicate with each other are connected to an access point (for example, the AP 131) that controls a network of the devices, and the devices communicate with each other via the access point. As one connection mode, the communication apparatus 151 can operate in a mode (infrastructure connection mode) for communication by infrastructure connection.

In infrastructure connection, each device searches for an access point by a device search command. After an access point is discovered, the device and the access point perform remaining wireless connection processing (establishment of wireless connection and the like) and then IP connection processing (assignment of an IP address and the like). Note that commands and parameters transmitted/received when implementing wireless connection between the device and the access point suffice to be those defined by the Wi-Fi standard, and a description thereof will be omitted here.

In this embodiment, when the communication apparatus 151 operates in infrastructure connection, the AP 131 operates as a master station and the communication apparatus 151 operates as a slave station. That is, in this embodiment, infrastructure connection means connection between the communication apparatus 151 operating as a slave unit and the apparatus operating as a master unit. In a case where the communication apparatus 151 establishes infrastructure connection and the information processing apparatus 101 also establishes infrastructure connection to the AP 131, the communication apparatus 151 and the information processing apparatus 101 can communicate with each other via the AP 131. Since the AP 131 decides a channel to be used for communication in infrastructure connection, the communication apparatus 151 executes communication in infrastructure connection using the channel decided by the AP 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the AP 131, the information processing apparatus 101 needs to recognize that the communication apparatus 151 belongs to a network which is formed by the AP 131 and to which the information processing apparatus 101 belongs.

### Network Setup Mode

The communication apparatus 151 can operate in the network setup mode. A trigger for the communication apparatus 151 to start an operation in the network setup mode may be, for example, the pressing of a network setup mode button by the user or activation (power-on) of the communication apparatus 151 for the first time after arrival. The network setup mode button may be a hardware (physical) button of the communication apparatus 151 or a software button displayed on the display unit 158 by the communication apparatus 151.

When the communication apparatus 151 starts an operation in the network setup mode, it enables Wi-Fi communication. More specifically, as Wi-Fi communication enabling processing, the communication apparatus 151 enables an internal AP (connection setting AP) of the communication apparatus 151 that is dedicated to the network setup mode. Then, the communication apparatus 151 can establish Wi-Fi direct connection to the information processing apparatus 101. Assume that connection information (Service Set Identifier (SSID) and password) for connection to the connection setting AP is held in advance in the predetermined application installed in the information processing apparatus 101, and the information processing apparatus 101 recognizes in advance the connection information for connection to the connection setting AP. Therefore, unlike connection information of an AP enabled in the direct connection mode, the connection information for connection to the connection setting AP cannot be changed arbitrarily by the user. Note that in the network setup mode, the communication apparatus 151 may be connected to the information processing apparatus 101 by not normal Wi-Fi but Wi-Fi Direct (WFD). That is, the communication apparatus 151 may operate as a group owner, and receive a setting command from the information processing apparatus 101 by WFD communication. Alternatively, the communication apparatus 151 may be connected to the information processing apparatus 101 by Bluetooth in the network setup mode. Bluetooth includes Bluetooth Classic and Bluetooth Low Energy (BLE). That is, for example, the communication apparatus 151 may operate as a slave apparatus in BLE in the network setup mode, and receive a setting command from the information processing apparatus 101 by BLE communication. Furthermore, in the network setup mode, the communication apparatus 151 may be able to execute both a network setup by Wi-Fi and a network setup by BLE. That is, when the communication apparatus 151 starts an operation in the network setup mode, it may enable both Wi-Fi communication and BLE communication. More specifically, when the communication apparatus 151 starts an operation in the network setup mode, it may enable both the connection setting AP and an advertising state in which BLE connection is enabled by transmitting advertising information by BLE.

When the communication apparatus 151 operates in the network setup mode, it controls the communication unit 156 to operate as a setup access point (connection setting AP) that is enabled only during an operation in the network setup mode. The setup access point is an access point different from that enabled in the above-described software AP mode. Assume that the SSID of the setup access point includes a predetermined character string recognizable by the predetermined application of the information processing apparatus 101.

Assume that the communication apparatus 151 operating in the network setup mode uses a predetermined communication protocol (setup communication protocol) in communication with the information processing apparatus 101 connected to the setup access point. More specifically, the setup communication protocol is, for example, Simple Network Management Protocol (SNMP).

If a predetermined time elapses after the communication apparatus 151 starts an operation in the network setup mode, the communication apparatus 151 stops the operation in the network setup mode and disables the setup access point. Furthermore, even when the connection information for connection to the AP 131 and a change instruction of the wireless communication operation mode are received from the information processing apparatus 101 in the network setup mode, the setup access point is disabled. Assume that the setup access point is an access point that does not require a password for connection. Note that the setup access point may be an access point that requires a password. In this case, a password used for connection to the setup access point is a fixed password (unchangeable by the user) that is grasped in advance by the predetermined application.

The short distance wireless communication unit 157 is a component wirelessly connected to the apparatus such as the information processing apparatus 101 in a short distance, and can be connected to, for example, the short distance wireless communication unit 111 in the information processing apparatus 101. As the communication method, for example, NFC, Bluetooth Classic, BLE, Wi-Fi Aware, or the like is used.

The RAM 153 is formed by an SRAM or the like, which needs a backup power supply. Note that the RAM 153 can store important data such as program control variables without volatilization because the data are held by a primary battery (not shown) for data backup. In addition, a memory area for storing setting information of the communication apparatus 151, management data of the communication apparatus 151, and the like is also provided in the RAM 153. Furthermore, the RAM 153 is used as the main memory and the work memory of the CPU 154 and a reception buffer to temporarily store print information received from the information processing apparatus 101 or the like or store various kinds of information.

The ROM 152 stores permanent data such as control programs to be executed by the CPU 154, data tables, and an OS program. In this embodiment, the control programs stored in the ROM 152 perform software execution control such as scheduling, task switch, and interrupt processing under the management of the embedded OS stored in the ROM 152. The ROM 152 also stores the serial number for identifying the communication apparatus 151. The serial number is uniquely assigned to identify the communication apparatus 151 by the manufacturer of the communication apparatus 151. The serial number can also be used as the apparatus identification information that can be used to identify the communication apparatus 151. In a case where the communication apparatus 151 is a printer, the use status and remaining amount of ink are collected from the print engine 155 and stored in the ROM 152. The CPU 154 is a system control unit and controls the whole communication apparatus 151.

Based on information stored in the RAM 153 or a print job received from the information processing apparatus 101 or the like, the print engine 155 forms an image on a print medium such as a paper sheet by applying a printing material such as ink onto the print medium, and outputs the print result. Note that in general, the data amount of the print job transmitted from the information processing apparatus 101 or the like is large, and thus it is necessary to use, for communication of the print job, a communication method that allows high-speed communication. Therefore, the communication apparatus 151 receives the print job via the communication unit 156 that can perform communication at a speed higher than that of the short distance wireless communication unit 157. The display unit 158 is, for example, a panel, and displays data or makes a notification concerning the state of the communication apparatus 151.

Note that a memory such as an external HDD or an SD card may be attached as an optional device to the communication apparatus 151, and information stored in the communication apparatus 151 may be stored in the memory.

After the information processing apparatus such as a personal computer or a smartphone executes a network setup for the communication apparatus such as a network printer to connect the communication apparatus to the access point, registration processing of the communication apparatus in the information processing apparatus is performed via the network of the access point. This allows the information processing apparatus to use the communication apparatus. In this registration processing, communication apparatus search processing is performed first on the network of the access point, and the communication apparatus selected by the user from the communication apparatuses discovered by the search processing is registered in the predetermined application.

There may exist a plurality of printers in an office, and communication apparatuses on a broadcast network are searched for. In an office environment, a desired communication apparatus may be on another subnet. When only one communication apparatus is discovered as a search result, if the communication apparatus is unconditionally registered in the predetermined application, the undesired communication apparatus may be registered. In this embodiment, it is possible to provide a mechanism for registering an appropriate communication apparatus in the predetermined application based on a search result on the network.

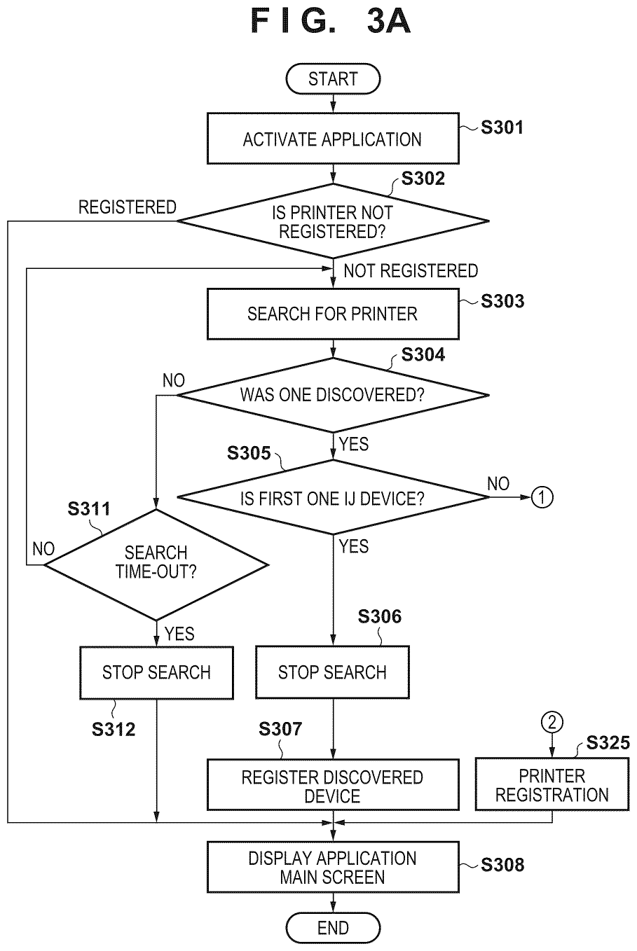

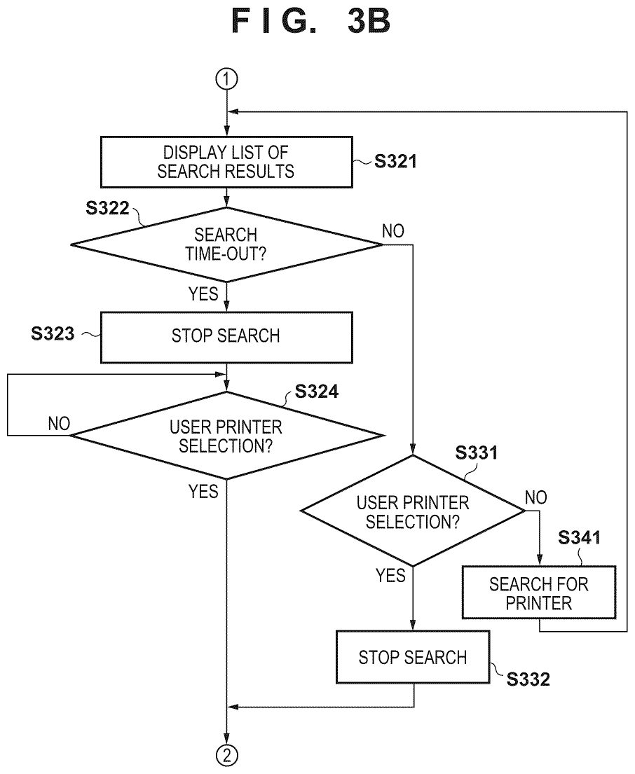

FIGS. 3A and 3B are flowcharts illustrating the registration processing of the communication apparatus according to this embodiment. The processing shown in FIGS. 3A and 3B is implemented when, for example, the CPU 103 of the information processing apparatus 101 reads out the program stored in the ROM 104 into the RAM 105 and executes it.

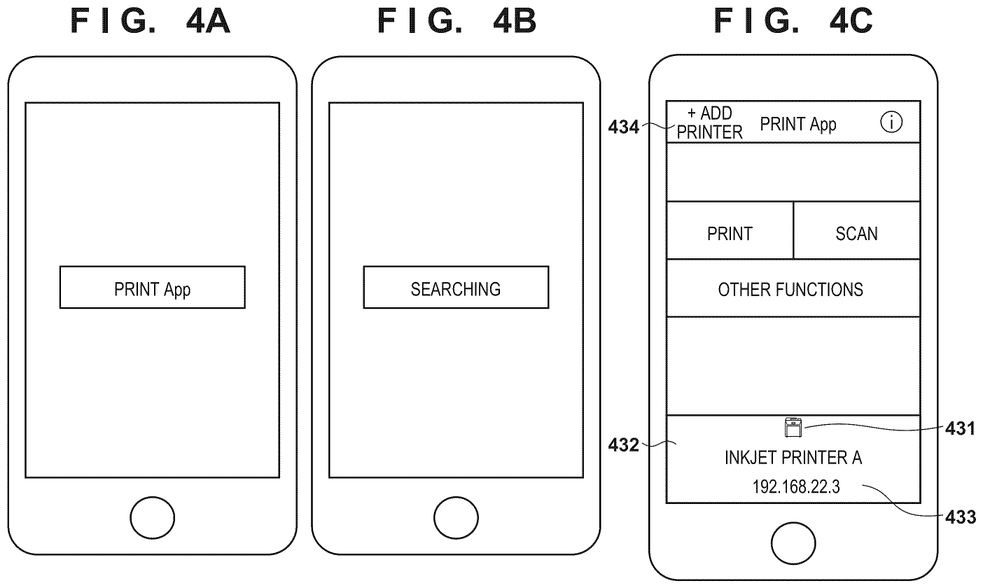

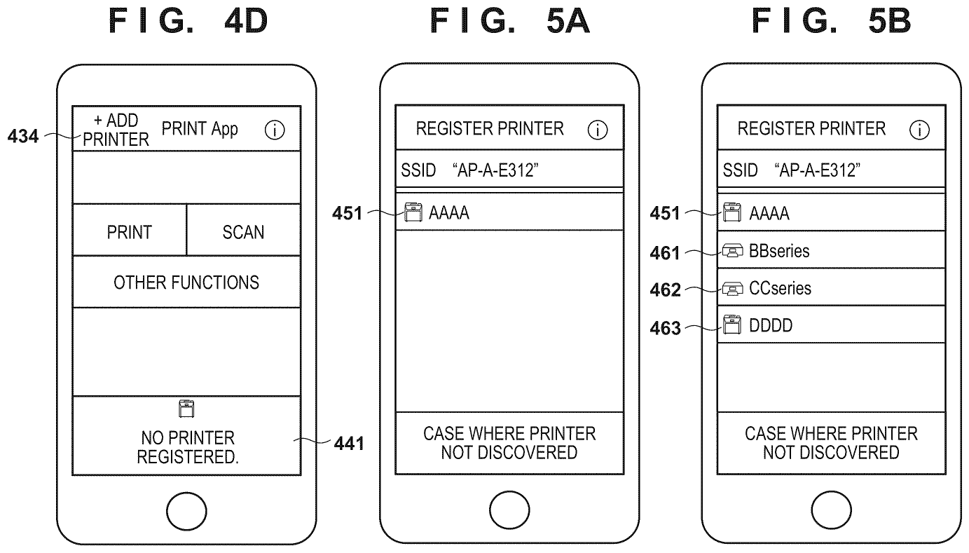

In step S301, the CPU 103 activates the predetermined application in the information processing apparatus 101 in response to a user operation such as a click or the like. The predetermined application (to be simply referred to as the application hereinafter) is, for example, the print application capable of instructing a printer to execute printing, as described above. Note that the function of the predetermined application is not limited to this example, and a network setup function of connecting a printer to an external access point may be executable. A function of managing information of a printer may be executable. The CPU 103 displays an application activation screen on the display unit 108 of the information processing apparatus 101. FIG. 4A is a view showing an example of the application activation screen.

In step S302, the CPU 103 determines whether a printer has been registered in the application. If it is determined that the printer has been registered, the process advances to step S308. If it is determined that the printer has not been registered, that is, no printer has been registered, the process advances to step S303.

In step S303, the CPU 103 starts a printer search on the network of the access point 131. The printer search is executed when, for example, the application sends a request to the Operating System (OS) using an API. The search executed here is, for example, a search by broadcast, as described above. That is, the search is processing of transmitting a search request (transmission packet) on the network to which the information processing apparatus 101 belongs, and receiving a response packet transmitted by an apparatus that responds to the search request. The network to which the information processing apparatus 101 belongs is a network formed by the access point connected to the information processing apparatus 101. Furthermore, the apparatus that has transmitted the received response packet is specified as an apparatus discovered by the search. The apparatus that has transmitted the received response packet is an apparatus that belongs to the network to which the information processing apparatus 101 belongs and that is connected to the access point connected to the information processing apparatus 101. Upon completion of the search, the application acquires a search result from the OS. Among the apparatuses discovered by the search as the search result acquired from the OS, the printer corresponding to the application may be specified. The printer corresponding to the application is, for example, a printer provided by a vendor that provides the application. Note that the transmission packet transmitted in the search may be controlled so that only a printer corresponding to the application responds to the search request. After the printer search is started, the CPU 103 displays a searching screen on the display unit 108 of the information processing apparatus 101. FIG. 4B is a view showing an example of the searching screen. Note that the executed search is not limited to the above-described form. For example, the search may be processing of specifying, by searching for and receiving beacons generated by an access point around the information processing apparatus 101, an apparatus that enables the access point that is generating the beacons. Alternatively, both processing of searching for apparatuses on the network to which the information processing apparatus 101 belongs and processing of searching for beacons generated by an access point around the information processing apparatus 101 may be executed.

In step S304, the CPU 103 determines whether the first printer has been discovered by the search started in step S303. If it is determined that no printer has been discovered, the process advances to step S311. If it is determined that the first printer has been discovered, the process advances to step S305.

In step S305, the CPU 103 determines whether the first printer discovered by the search started in step S303 is an inkjet printer. In other words, the first printer discovered by the search started in step S303 is a printer discovered firstly by the search started in step S303. The inkjet printer is a printer that executes printing by an inkjet method, and a printer that executes printing using ink as a printing material. For example, the application may manage network information such as a MAC address and an IP address and model information such as a serial number in linkage with each other. If it is determined that the firstly discovered printer is an inkjet printer, the process advances to step S306. If it is determined that the firstly discovered printer is not an inkjet printer, the process advances to step S321. Note that the printer that is not an inkjet printer is, for example, a laser beam printer. The laser beam printer is a printer that executes printing by the electrophotographic method, and a printer that executes printing using toner as a printing material.

In step S306, the CPU 103 stops the printer search started in step S303. More specifically, the stop of the search indicates a stop of the transmission of the search request (transmission packet) started in step S303 or a stop of the reception of the response packet. Alternatively, for example, the stop of the search indicates a stop of the reception of the beacons generated by the access point around the information processing apparatus 101. Then, in step S307, the CPU 103 registers, as a printer to be used in the application, the inkjet printer discovered in step S304. The printer registered here is the printer discovered firstly by the search started in step S303. As described above, more specifically, the registration of the printer in the application is, for example, processing of acquiring the capability information and identification information of the printer from the printer and storing these pieces of information in the application. In other words, the printer registered in the application is a printer corresponding to the capability information and the identification information stored in the application. Then, these pieces of information stored in the registration are used for UI display by the application at the time of printing. For example, if the capability information of a monochrome printer is acquired, display control is performed such that only monochrome printing is selectable in a print menu (not shown) at the time of printing. Furthermore, the application can display a list of the printers registered in the application. The application can transmit a print job to the printer selected by the user from the list. In step S308, the CPU 103 displays an application screen on the display unit 108 of the information processing apparatus 101. If the process advances from step S307 to step S308, a printer registration screen shown in FIG. 4C is displayed as the application screen. As shown in FIG. 4C, as the registered inkjet printer, an icon 431, a printer name 432, and an IP address 433 are displayed. In this embodiment, in a case where the process advances to step S307 (YES is determined in step S305), the CPU 103 registers the printer without displaying the search result or accepting, from the user, the selection of one printer from the search result (selection acceptance processing) in step S321 and the like. Note that before registering the printer in step S307, the CPU 103 may display a screen showing a printer to be registered (the printer discovered firstly by the search started in step S303) or a confirmation screen for confirming whether to register the printer. On these screens, for example, the identification information of the printer such as the name, SSID, and model name of the printer can be displayed. If a user operation indicating that the printer may be registered is accepted on the confirmation screen, the process may advance to step S307. If a user operation not indicating that the printer may be registered is accepted on the confirmation screen, the process may advance to step S321.

As described above, according to this embodiment, if the firstly discovered printer is a printer of a predetermined model (more specifically, for example, a model corresponding to an inkjet printer), the printer search is stopped and the printer is registered in the application without accepting a user instruction. This can improve convenience and minimize network communication associated with the device search.

If it is determined in step S304 that no printer has been discovered, the CPU 103 determines, in step S311, whether a time-out of the printer search started in step S303 has occurred. More specifically, for example, it is determined whether a predetermined time such as 10 sec has elapsed after the display of the searching screen shown in FIG. 4B and the start of the printer search. If it is determined that a time-out has occurred, the process advances to step S312. If it is determined that a time-out has not occurred, the processing is repeated from step S303. That is, the transmission of the search request and the reception of the response packet are continuously performed.

In step S312, the CPU 103 stops the printer search started in step S303. More specifically, the stop of the search indicates a stop of the transmission of the search request started in step S303 or a stop of the reception of the response packet. Then, in step S308, the CPU 103 displays the application screen on the display unit 108 of the information processing apparatus 101. If the process advances from step S312 to step S308, a screen indicating that no printer has been registered is displayed as the application screen, as shown in FIG. 4D.

If it is determined in step S305 that the first printer is a printer other than an inkjet printer, the CPU 103 displays, in step S321, the search result as a list on the display unit 108 of the information processing apparatus 101. Then, the CPU 103 waits for accepting, from the user, selection of one printer from the search result. FIG. 5A is a view showing an example of a search result screen when one laser beam printer 451 is displayed as a search list. As shown in FIG. 5A, model information is displayed as the search result. FIG. 5B is a view showing an example of the search result screen when a plurality of printers 451, 461, 462, and 463 are discovered and displayed as a list by repeating the search in steps S331 to S341 (to be described later). As shown in FIG. 5B, model information is displayed as a search result. Furthermore, as shown in FIG. 5B, an icon is switched and displayed in accordance with the printing method of the printer. Therefore, even if many printers are discovered, the user can readily find a printer of a desired model. Referring to FIG. 5B, display is switched between two kinds of icons but may be switched among two or more kinds of icons. For example, a large format printer whose sheet size is A1 or larger may be displayed by an icon unique to this printer.

In step S322, the CPU 103 determines whether a time-out of the printer search started in step S303 has occurred, similar to step S311. If it is determined that a time-out has occurred, the process advances to step S323. If it is determined that a time-out has not occurred, the process advances to step S331.

In step S323, the CPU 103 stops the printer search started in step S303. The processing in step S323 is the same as that in step S306 or S312. Then, in step S324, the CPU 103 determines whether selection of the printer by the user is accepted on the screen shown in FIG. 5A or 5B. If it is determined that selection of the printer is accepted, the process advances to step S325. The processing in step S324 is repeated until it is determined that selection of the printer is accepted.

In step S325, the CPU 103 registers, as a printer to be used in the application, the printer selected in step S324 or S331. In step S308, the CPU 103 displays the application screen on the display unit 108 of the information processing apparatus 101. If the process advances from step S325 to step S308, a printer registration screen that displays the registered printer information is displayed as the application screen.

As described above, according to this embodiment, if the firstly discovered printer is a printer of a model (more specifically, for example, a model corresponding to an laser beam printer) that is not the predetermined model and a time-out of the printer search occurs, the printer is displayed as a list, user selection is accepted, and then the printer is registered in the application. This can prevent the printer undesired by the user from being automatically registered.

If it is determined in step S322 that a time-out has not occurred, the CPU 103 determines, in step S331, whether selection of the printer by the user is accepted on the screen shown in FIG. 5A or 5B. If it is determined that selection of the printer is accepted, the process advances to step S332. In step S332, the CPU 103 stops the printer search started in step S303, and advances to step S325. The processing in step S332 is the same as that in step S306 or S312.

If it is determined in step S331 that selection of the printer by the user is not accepted, the CPU 103 continues the printer search in step S341 and repeats the processing from step S321. Note that since the printer search is continued, a printer may newly be discovered in step S341. The screen shown in FIG. 5B is an example of the screen displayed when a printer is newly discovered.

As described above, according to this embodiment, in accordance with whether the firstly discovered printer is an inkjet printer as a home printer or a laser beam printer as an office printer, automatic registration and registration after list display and user selection are switched. This arrangement can implement registration processing according to the result of the printer search on the network.

In this embodiment, the processing shown in FIGS. 3A and 3B has been explained as the processing executed at the time of activation of the application. However, the processing shown in FIGS. 3A and 3B may be executed at another timing. For example, the processing shown in FIGS. 3A and 3B may be executed when an automatic search is instructed on the application in a state in which no printer is registered.

Even if the firstly discovered printer is a printer other than an inkjet printer, a list is not displayed before the second or subsequent printer is discovered, and a list may be displayed at a timing when the second or subsequent printer is discovered. More specifically, for example, if only one printer is discovered in step S321, a list is not displayed, and a list may be displayed at a timing when the second or subsequent printer is discovered.

Even if the firstly discovered printer is a printer other than an inkjet printer, a list is not displayed before a time-out of a search time occurs, and when a time-out of the search time occurs, printers discovered until now may be displayed as a list. More specifically, for example, the screen shown in FIG. 5A or 5B may be displayed after step S323 without performing the processing in step S321.

Even if the firstly discovered printer is a printer other than an inkjet printer, if the second and subsequent printers are not discovered before a time-out of the search time occurs, the first printer may automatically be registered without displaying a list.

In FIGS. 3A and 3B, if the firstly discovered printer is an inkjet printer, the printer search is stopped in step S306 and the printer is registered in step S307. However, if the printer search continues in the application, and the second and subsequent printers are discovered before a time-out of the search time occurs (not shown), a confirmation message indicating whether the first registered printer is a printer desired by the user may be displayed on the display unit 108.

Before displaying a list, a screen for confirming, with the user, whether to display a list may be displayed on the display unit 108, and if an instruction to display a list is accepted, a list may be displayed. If there is no instruction on the confirmation screen, a list may be displayed without registering the printer. Alternatively, one discovered printer (for example, the firstly discovered printer) may automatically be registered.

### Second Embodiment

The second embodiment will be described below concerning points different from the first embodiment. In the first embodiment, when a printer search is executed and a printer is registered in the application, the registration processing is switched in accordance with the type of the firstly discovered printer. In this embodiment, when a communication apparatus 151 is connected to an access point 131 (connection setting is performed) at the time of purchase of a printer or the like, an application of an information processing apparatus 101 searches for the communication apparatus 151 in a network setup state. Then, the information processing apparatus 101 is connected to the communication apparatus 151 by wireless communication, and transmits, to the communication apparatus 151, information for connection to the access point 131. After that, the information of the communication apparatus 151 is registered in the application of the information processing apparatus 101 via the network of the access point 131. Note that the above connection setting operation is called a network setup.

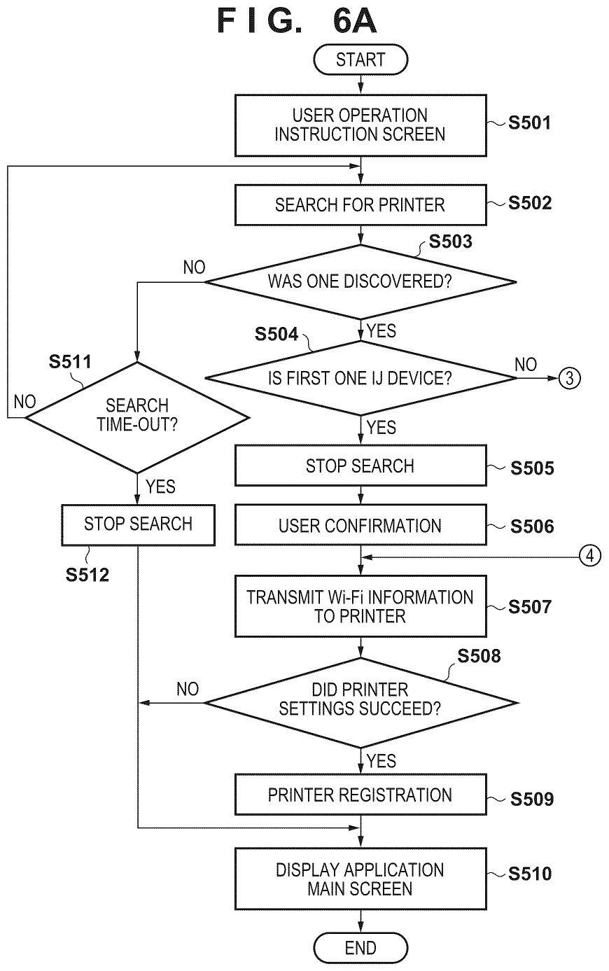

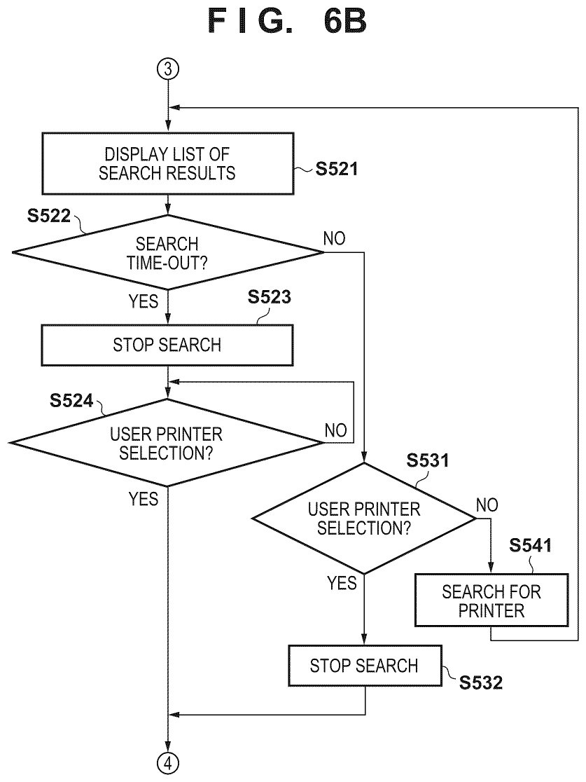

FIGS. 6A and 6B are flowcharts illustrating registration processing of the communication apparatus according to this embodiment. The processing shown in FIGS. 6A and 6B is implemented when, for example, a CPU 103 of the information processing apparatus 101 reads out a program stored in a ROM 104 into a RAM 105 and executes it.

In step S501, the CPU 103 activates a predetermined application in the information processing apparatus 101 in response to a user operation such as a click or the like. The predetermined application (to be simply referred to as the application hereinafter) is, for example, an application capable of executing a network setup function of connecting an external printer to an external access point. Note that the predetermined application may have not only the function but also a function of causing the printer to execute printing.

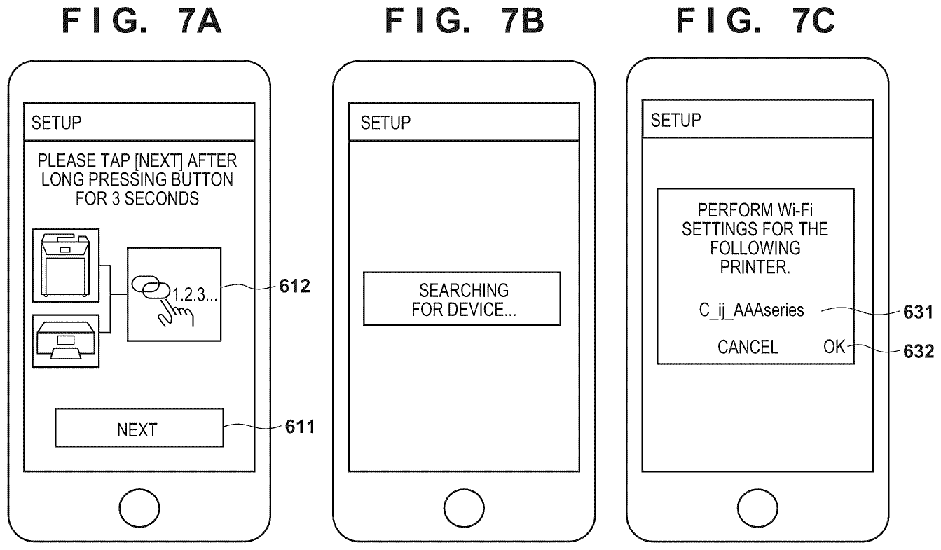

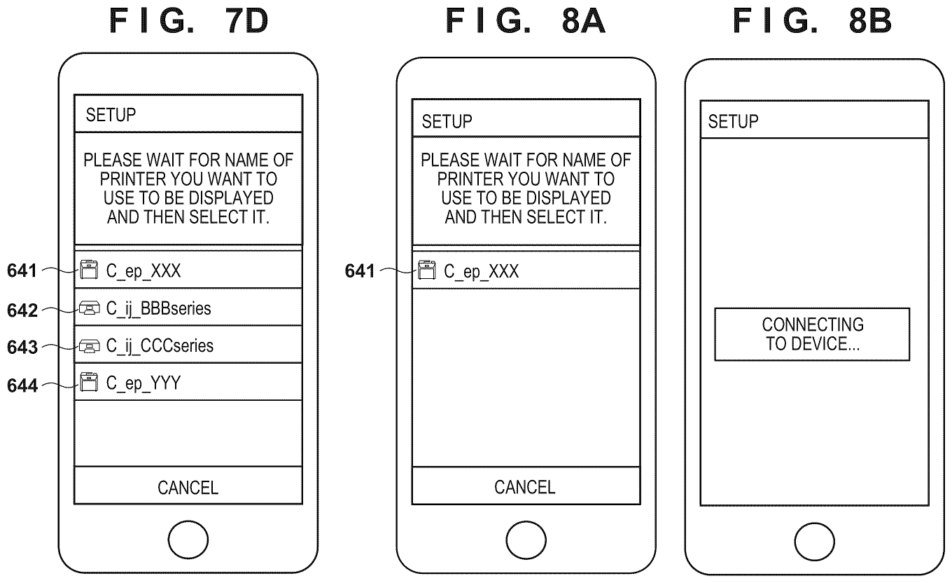

The CPU 103 displays a network setup guidance screen on a display unit 108 of the information processing apparatus 101. FIG. 7A is a view showing an example of the network setup guidance screen. On the guidance screen, a procedure 612 for pressing a network setup start button on the printer and transitioning the printer to a network setup state is displayed. The user views the screen shown in FIG. 7A, and presses a network setup start button (not shown) of the desired communication apparatus 151. Upon the pressing of the network setup start button, the communication apparatus 151 transitions to the network setup state, and shifts to a Wi-Fi communication state for communication with the application. More specifically, for example, a communication unit 156 is operated in an access point state of an SSID including the model name of the self-apparatus such as “Canon_ij_AAASeries”, thereby waiting for connection from the outside. In step S501, the CPU 103 waits for the user to press a next button 611. If the pressing of the next button 611 is accepted, the process advances to step S502. Note that at this time, the communication apparatus 151 has transitioned to the network setup state.

In step S502, the CPU 103 starts a printer search. In this embodiment, a search is executed based on whether a character string of an SSID transmitted by a peripheral access point by wireless communication has a predetermined format representing the model name of a printer corresponding to the application. More specifically, for example, a search is executed based on whether the character string has a format of “Canon_ij_nnnn_model name” indicating an inkjet printer or “Canon_ep_nnnn_model name” indicating a laser beam printer.

After the printer search is started, the CPU 103 displays a searching screen on the display unit 108 of the information processing apparatus 101. FIG. 7B is a view showing an example of the searching screen.

In step S503, the CPU 103 determines whether the first printer has been discovered by the search by the SSID. If it is determined that no printer has been discovered, the process advances to step S511. If it is determined that the first printer has been discovered, the process advances to step S504.

In step S504, the CPU 103 determines whether the firstly discovered printer is an inkjet printer. More specifically, for example, it is determined whether the SSID has a format of “Canon_ij_nnnn_model name”. If it is determined that the firstly discovered printer is an inkjet printer, the process advances to step S505. If it is determined that the firstly discovered printer is not an inkjet printer, the process advances to step S521.

In step S505, the CPU 103 stops the printer search started in step S502. In step S506, the CPU 103 displays a confirmation screen shown in FIG. 7C on the display unit 108 of the information processing apparatus 101. The confirmation screen shown in FIG. 7C is an example of a screen for prompting the user to confirm whether the discovered printer has a printer name 631 representing a desired printer for which a network setup is to be performed. If the user presses an OK button 632, the process advances to step S507. The processing in step S506 need not be performed and the process may advance from step S505 to step S507.

In step S507, the CPU 103 displays a device connecting screen on the display unit 108 of the information processing apparatus 101. FIG. 8B is a view showing an example of the device connecting screen. That is, in step S507, the application performs wireless connection to the SSID of the communication apparatus 151 discovered by the search and operating as a master station. Then, the application transmits, to the communication apparatus 151 via wireless connection, connection information for connection to the access point 131. More specifically, for example, the application transmits the SSID and passkey of the access point 131 to the communication apparatus 151. The communication apparatus 151 is connected to the access point 131 using the received SSID and passkey.

In step S508, the CPU 103 switches a Wi-Fi connection destination to the access point 131 again. Then, the CPU 103 determines whether it is possible to execute communication with the communication apparatus 151 via the access point 131. This communication is, for example, communication for registering the capability information of the communication apparatus 151 in the application of the information processing apparatus 101, as described in the first embodiment. If it is determined in step S508 that it is possible to execute communication, that is, the network setup of the communication apparatus 151 has succeeded, the process advances to step S509. If it is determined that it is impossible to execute communication, that is, the network setup of the communication apparatus 151 has failed, the process advances to step S510.

In step S509, the CPU 103 registers, in the application, the information of the communication apparatus 151 for which it is determined in step S508 that it is possible to execute communication. In step S510, the CPU 103 displays an application screen on the display unit 108 of the information processing apparatus 101. If the process advances from step S509 to step S510, a printer registration screen shown in FIG. 4C is displayed as the application screen. That is, as shown in FIG. 4C, as the registered inkjet printer, an icon 431, a printer name 432, and an IP address 433 are displayed.

If it is determined in step S503 that no printer has been discovered, the CPU 103 determines, in step S511, whether a time-out of the printer search started in step S502 has occurred. More specifically, for example, it is determined whether a predetermined time such as 10 sec has elapsed after the display of the searching screen shown in FIG. 7B and the start of the printer search. If it is determined that a time-out has occurred, the process advances to step S512. If it is determined that a time-out has not occurred, the processing is repeated from step S502.

In step S512, the CPU 103 stops the printer search started in step S502. In step S510, the CPU 103 displays the application screen on the display unit 108 of the information processing apparatus 101. If the process advances from step S512 to step S510 or it is determined in step S508 that it is impossible to execute communication, a screen indicating that no printer has been registered is displayed as the application screen, as shown in FIG. 4D.

If it is determined in step S504 that the first printer is a printer other than an inkjet printer, the CPU 103 displays, in step S521, the search result as a list on the display unit 108 of the information processing apparatus 101. FIG. 8A is a view showing an example of a search result screen when one laser beam printer 641 is displayed as a search list. FIG. 7D is a view showing an example of the search result screen displayed when a plurality of printers 641, 642, 643, and 644 are discovered and displayed as a list by repeating the search in steps S531 to S541 (to be described later). As shown in FIG. 7D, an icon is switched and displayed in accordance with the printing method of the printer. Therefore, even if many printers are discovered, the user can readily find a desired printer. Referring to FIG. 7D, display is switched between two kinds of icons but may be switched among two or more kinds of icons. For example, a large format printer whose sheet size is A1 or larger may be displayed by an icon unique to this printer.

In step S522, the CPU 103 determines whether a time-out of the printer search started in step S502 has occurred. The processing in step S522 is the same as that in step S511. If it is determined that a time-out has occurred, the process advances to step S523. If it is determined that a time-out has not occurred, the process advances to step S531.

In step S523, the CPU 103 stops the printer search started in step S502. Then, in step S524, the CPU 103 determines whether selection of the printer by the user is accepted on the screen shown in FIG. 7D or 8A. If it is determined that selection of the printer is accepted, the process advances to step S507. The processing in step S524 is repeated until it is determined that selection of the printer is accepted.

If it is determined in step S522 that a time-out has not occurred, the CPU 103 determines, in step S531, whether selection of the printer by the user is accepted on the screen shown in FIG. 7D or 8A. If it is determined that selection of the printer is accepted, the process advances to step S532. If it is determined that selection of the printer is not accepted, the process advances to step S541.

In step S532, the CPU 103 stops the printer search started in step S502. Then, the process advances to step S507. If it is determined, in step S531, that selection of the printer by the user is not accepted, the CPU 103 continues the printer search in step S541, and repeats the processing from step S521. Since the printer search is continued, a printer may newly be discovered in step S541. The screen shown in FIG. 7D is an example of the screen displayed when a printer is newly discovered.

As described above, according to this embodiment, in accordance with whether the firstly discovered printer is an inkjet printer as a home printer or a laser beam printer as an office printer, whether to display a list of printers for which a network setup is to be performed is switched. This arrangement can implement registration processing according to the result of the printer search.

Referring to FIG. 7D, a plurality of printers in the network setup state are displayed at the same time. As described with reference to FIGS. 6A and 6B, in step S501, a guidance is displayed to prompt the user to press the button on the printer to transition to the network setup state. When the user purchases a printer and powers on the printer for the first time, it is necessary to perform connection setting to the access point 131, and thus the printer may be configured to automatically transition to a network setup request standby state (that is, the network setup state) at the time of power-on of the printer for the first time. Therefore, for example, if the user purchases a plurality of printers at the same time, and powers on the printers at the same time, there exist a plurality of printers that stand by in the network setup state. In this case, the screen is displayed, as shown in FIG. 7D.

### Third Embodiment

In the above description, the processing is witched based on whether the discovered printer is an inkjet printer or a laser beam printer. However, the present invention is not limited to this form. That is, the type of the printer referred to when switching the processing needs to be neither the inkjet printer nor the laser beam printer. More specifically, for example, the processing may be switched based on whether the discovered printer is a printer that executes printing on a standard cut sheet or a printer that executes printing on a large-sized roll sheet. In this form, for example, if the discovered printer is a printer that executes printing on a standard cut sheet, the processing described in the above embodiment as processing executed based on the fact that the discovered printer is an inkjet printer is executed. Alternatively, for example, if the discovered printer is a printer that executes printing on a large-sized roll sheet, the processing described in the above embodiment as processing executed based on the fact that the discovered printer is a laser beam printer is executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-161708, filed Sep. 25, 2023, which is hereby incorporated by reference herein in its entirety.

What is claimed is:

1. A control method for an information processing apparatus including a predetermined application program, comprising:
executing search processing for searching for a communication apparatus by the information processing apparatus; and
executing predetermined communication with a communication apparatus discovered by a search started by the search processing,
wherein based on a fact that a communication apparatus discovered firstly by the search is an apparatus of a first type, the predetermined communication with the communication apparatus discovered firstly by the search is executed without displaying, after the search processing is executed, a selection screen for accepting selection of one of a plurality of communication apparatuses from a user,
based on a fact that the communication apparatus discovered firstly by the search is an apparatus of a second type different from the first type,
the selection screen is displayed,
the plurality of communication apparatuses discovered by the search are displayed on the selection screen, and
the predetermined communication with the communication apparatus selected by the user from the plurality of communication apparatuses displayed on the selection screen is executed.

2. The method according to claim 1, further comprising executing, based on the fact that the communication apparatus discovered firstly by the search is the apparatus of the first type, processing for stopping the search.

3. The method according to claim 1, wherein in a case where the communication apparatus discovered firstly by the search is the apparatus of the second type, the search is continued.

4. The method according to claim 3, further comprising:
determining, after the communication apparatus as the apparatus of the second type is discovered firstly by the search, whether a predetermined time has elapsed after the start of the search; and
executing, based on determination that the predetermined time has elapsed after the start of the search, processing for stopping the search.

5. The method according to claim 3, wherein
in a case where the communication apparatus as the apparatus of the second type is discovered firstly by the search, the plurality of communication apparatuses discovered by the search are displayed on the selection screen in a state in which the search is continued, and
processing for stopping the search is executed based on a fact that one of the plurality of communication apparatuses displayed on the selection screen is selected in the state in which the search is continued.

6. The method according to claim 1, wherein processing for stopping the search is executed based on a fact that a predetermined time has elapsed after the start of the search without discovering the communication apparatus.

7. The method according to claim 1, wherein the apparatus of the first type is an inkjet printer.

8. The method according to claim 1, wherein the apparatus of the second type is a laser beam printer.

9. The method according to claim 1, wherein the search processing is processing for searching for the communication apparatus on a network of an access point to which the information processing apparatus is connected.

10. The method according to claim 1, wherein the search processing is processing for searching for the communication apparatus that operates in a predetermined mode of receiving information concerning an access point from the information processing apparatus.

11. The method according to claim 1, wherein the predetermined communication is communication for registering, in the predetermined application program, the communication apparatus as an apparatus that can communicate by the predetermined application program.

12. The method according to claim 11, wherein
the communication apparatus is registered, in the predetermined application program, as the apparatus that can communicate by the predetermined application program, by acquiring information concerning the communication apparatus by the predetermined communication, and
the information concerning the communication apparatus includes at least one of identification information of the communication apparatus and capability information of the communication apparatus.

13. The method according to claim 11, wherein
the predetermined communication includes communication for transmitting information concerning an access point to the communication apparatus, and
in a case where the information concerning the access point is transmitted to the communication apparatus, the communication apparatus is connected to the access point using the information concerning the access point.

14. The method according to claim 13, wherein after the predetermined communication is executed, based on a fact that it is possible to execute communication with the communication apparatus via the access point, the communication apparatus is registered, in the predetermined application program, as the apparatus that can communicate by the predetermined application program.

15. The method according to claim 1, wherein
a confirmation screen for confirming whether to execute the predetermined communication with the communication apparatus discovered firstly by the search is displayed based on the fact that the communication apparatus discovered firstly by the search is the apparatus of the first type,
in a case where an operation corresponding to execution of the predetermined communication with the communication apparatus discovered firstly by the search is accepted on the confirmation screen, the predetermined communication with the communication apparatus discovered firstly by the search is executed without displaying the selection screen after the search processing is executed,
in a case where an operation corresponding to non-execution of the predetermined communication with the communication apparatus discovered firstly by the search is accepted on the confirmation screen, the selection screen is displayed after the search processing is executed, and
the predetermined communication with the communication apparatus selected by the user from the plurality of communication apparatuses displayed on the selection screen is executed.

16. The method according to claim 1, further comprising transmitting a print job to the communication apparatus registered in the predetermined application program.

17. The method according to claim 1, wherein the search processing is executed based on activation of the predetermined application program.

18. The method according to claim 1, wherein
in a case where the communication apparatus is not registered, in the predetermined application program, as an apparatus that can communicate by the predetermined application program, the search processing is executed based on activation of the predetermined application program, and
in a case where the communication apparatus is registered, in the predetermined application program, as the apparatus that can communicate by the predetermined application program, the search processing is not executed even at a time of activation of the predetermined application program.

19. An information processing apparatus comprising:
at least one processor and at least a memory coupled to the at least one processor and having instructions stored thereon, and when executed by the at least one processor, acting as:
a search unit configured to execute search processing for searching for a communication apparatus by the information processing apparatus; and
a communication unit configured to execute predetermined communication with a communication apparatus discovered by a search started by the search processing,
wherein based on a fact that a communication apparatus discovered firstly by the search is an apparatus of a first type, the predetermined communication with the communication apparatus discovered firstly by the search is executed without displaying, after the search processing is executed, a selection screen for accepting selection of one of a plurality of communication apparatuses from a user,
based on a fact that the communication apparatus discovered firstly by the search is an apparatus of a second type different from the first type, the selection screen is displayed,
the plurality of communication apparatuses discovered by the search are displayed on the selection screen, and
the predetermined communication with the communication apparatus selected by the user from the plurality of communication apparatuses displayed on the selection screen is executed.

20. A non-transitory computer-readable storage medium that stores one or more programs including instructions, which when executed by one or more processors of an information processing apparatus including a predetermined application program, cause the information processing apparatus to perform a method, the method comprising:
executing search processing for searching for a communication apparatus by the information processing apparatus; and
executing predetermined communication with a communication apparatus discovered by a search started by the search processing,
wherein based on a fact that a communication apparatus discovered firstly by the search is an apparatus of a first type, the predetermined communication with the communication apparatus discovered firstly by the search is executed without displaying, after the search processing is executed, a selection screen for accepting selection of one of a plurality of communication apparatuses from a user,
based on a fact that the communication apparatus discovered firstly by the search is an apparatus of a second type different from the first type, the selection screen is displayed,
the plurality of communication apparatuses discovered by the search are displayed on the selection screen, and
the predetermined communication with the communication apparatus selected by the user from the plurality of communication apparatuses displayed on the selection screen is executed.
